(19) United States
(12) Patent Application Publication
(10) Pub. No.: US 2012/0300598 A1
(43) Pub. Date: Nov. 29, 2012

(54) Alarm clock with adjustment function

(76) Inventors: Rebecca Michelle Murray, Greenwich, CT (US); Michael Martin Murray, Greenwich, CT (US)

(21) Appl. No.: 13/134,018

(22) Filed: May 26, 2011

(51) Int. Cl. G04C 21/16

(52) U.S. Cl. 368/251; 368/250

(57) ABSTRACT

An alarm clock that will adjust a wake-up time set by a user based on the detection of a predetermined external event that is not based on user input. Examples of such external events are school closings broadcast over a radio station and flight cancellations listed on an airline's website. The adjustment can be deactivating the alarm or changing the wake time based on the event, e.g., a one hour flight delay can be set to adjust the alarm by one hour.

### FIELD OF THE INVENTION

This invention relates to the field of alarm clocks and, in certain embodiments, to an improved system and method for determining the time at which a user is awakened.

### BACKGROUND OF THE INVENTION

Alarm clocks are commonly used for waking users at specified times. While it may be preferable to allow the body to wake up naturally once it is fully rested, the demands of daily life, including school and/or work, often require getting up at a specified time. A typical alarm clock includes a series of buttons for setting both the time of day and the time for activation of the alarm. Many alarms also feature so-called snooze buttons allowing the user to reset the alarm after it activates to activate again after a predetermined delay, typically 9 minutes. Alarm clocks can use a variety of methods to wake the user, including audible tones, vibration and odors.

### SUMMARY OF THE INVENTION

In one aspect, the invention features an alarm clock that will adjust a wake-up time set by a user, the alarm clock including a processor and a memory coupled to the processor having stored therein a wake-up time as set by a user. An event detector is coupled to the processor and will detect the occurrence of a predetermined external event from a source other than a user of the alarm clock. Examples of such external events are school closings broadcast over a radio station and flight cancellations listed on an airline's website.

The memory may have stored therein instructions that, when executed, will cause the processor to perform the steps of (1) receiving a signal from the event detector indicating the occurrence of the predetermined external event and (2) adjusting the stored wake-up time based on the received signal.

The alarm clock can adjust the stored wake-up time by a predetermined amount of time when the event is detected or deactivate the alarm so as to not wake the user at the stored wake-up time.

In another aspect, the invention features an alarm clock that will adjust a wake-up time set by a user based on a detected external event, the alarm clock comprising a processor and memory having stored therein instructions that, when executed, will cause the processor to perform the following steps: (1) setting an initial wake-up time based on user input; (2) recognizing the occurrence of a predetermined external event from a source other than a user of the alarm clock; and (3) adjusting the initial wake up time based on the recognized occurrence of the predetermined external event.

The step of adjusting may comprise changing said stored wake-up time by a predetermined amount of time, e.g., by one hour. The memory may have additional instructions that will cause the processor to perform the additional step of activating an alarm based on the adjusted wake-up time. The adjusting may also comprise deactivating the alarm so that it will not wake the user at the stored wake-up time.

The recognizing step may comprise monitoring at least one public data transmission (e.g., radio or television) for the occurrence of at least one key word in the data transmission. For example, the name of a relevant school can constitute the key word.

In another aspect, the invention features a method for operating an alarm clock comprising the steps of (1) receiving user input setting an initial wake-up time, (2) monitoring a public broadcast source for the occurrence of a predetermined event, and (3) adjusting the initial wake up time to an adjusted wake-up time based on the recognized occurrence of the predetermined event. As with other aspects discussed above, the step of adjusting may comprise changing the initial wake-up time by a predetermined amount of time or deactivating the alarm altogether to avoid waking the user.

### BRIEF DESCRIPTION OF THE DRAWINGS

FIG. 1 is a block diagram of one embodiment of an alarm clock in accordance with the present invention.

FIG. 2 is a flowchart showing one example of a method for implementing the embodiment of the invention shown in FIG. 1.

### DETAILED DESCRIPTION OF CERTAIN EMBODIMENTS

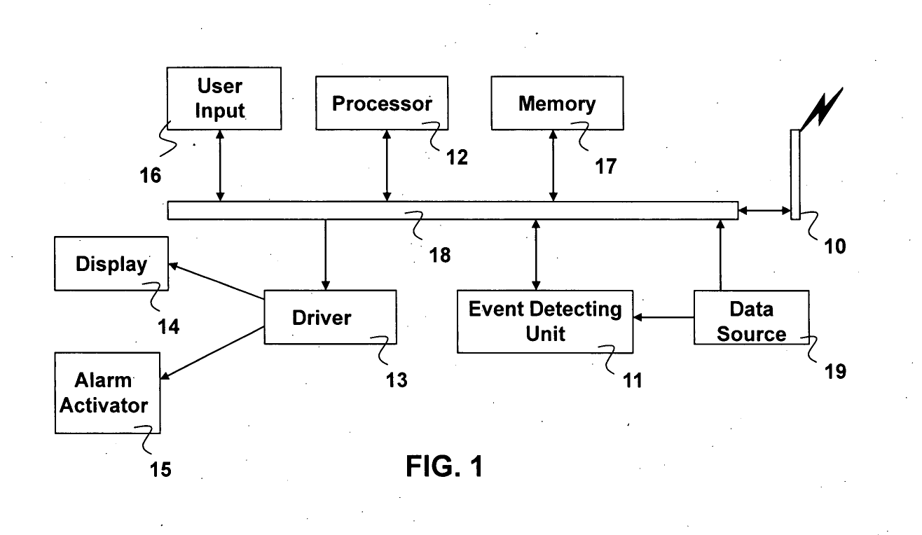

Referring to FIG. 1, a block diagram of one embodiment of an alarm clock of the present invention is illustrated and includes an antenna system 10 having an antenna and associated circuitry, an event detecting unit 11, a processor 12, and a driver 13 that drives a display 14 and an alarm activator 15. A user input device 16 and memory 17 are coupled to the foregoing components via a data bus 18. A data source 19 communicates with event detecting unit 11 either directly or through data bus 18.

User input 16 can be any suitable input device such as a touch screen, a series of buttons, a voice recognition system, etc. Memory 17 is preferably a memory that allows for rapid storage and retrieval (e.g. RAM or FLASH), but could be any suitable memory, including a hard disk. Antenna system 10 includes typical circuitry and hardware to enable successful receipt of any transmitted signal. This may include memory, a processor, error correction, security circuitry, and appropriate software.

Event detecting unit 11 includes hardware, software and memory to receive and monitor any source of data that a user would like to monitor for a particular event, and/or to monitor for a particular signal indicative of the event, as described further below. Examples of appropriate data sources include radio stations (e.g., broadcast, Internet), television stations, websites, and telephone lines (land line or cellular). Event detector 11 can work with antenna system 10 or can receive data through another data source 19, such as wifi, hard-wired Internet connection, cable television line, wired or cellular telephone lines, fiber optic line, satellite dish, etc. Event detecting unit 11 can function under the control of processor 12 or can include its own processor. Monitoring and event detection systems in connection with alarm clocks are known in the art and include, e.g., U.S. Pat. No. 7,715,278, incorporated herein by reference.

The display 14 typically is an LED or similar display that shows the time of day and/or the alarm set time. Other data and graphics can also be displayed such as weather, news, and a radio station tuner display. Processor 12 can be a microprocessor or an integrated circuit that includes memory and software necessary for optimal operation. The processor 12 preferably controls the basic clock functions of keeping and displaying the correct time. Alternatively, a dedicated clock unit can be connected to the system, such as a quartz crystal clock or spring-based clock.

Driver 13 is selected based on the display and alarm activator 15. For example, if the alarm activator is a speaker system that will play an audible tone, then driver 13 will receive a message from processor 12 when the alarm is to be activated and will generate appropriate analog signals to drive a speaker. Similarly, depending on the chosen display 14, the driver 13 will be chosen to generate and provide the necessary input to properly drive the display. Instead of a single driver to drive both the display and alarm activator, it may be preferable to use separate drivers for each as will be understood by those skilled in the art.

Bus 19 can be any suitable serial or parallel bus that facilitates communications between the various components. Furthermore, any other communications system can be substituted that will allow for the necessary communications, including a LAN, Ethernet, wireless routers, etc.

In one aspect the system of FIG. 1 can function as follows. A user can set the time of day of the clock using input device 16, and can also set a time for the alarm to be activated, i.e., the “wake time.” Processor 12 controls the display through driver 13 to display the correct time of day, updating every second or as desired. Memory 17 may be used by processor 12 to store relevant data including the wake time. In the absence of a detected event, the processor 12 will control the alarm activator to activate the alarm through driver 13 when the time of day matches the user selected wake time, as is typical in alarm clock operation.

Event detecting unit will monitor for a predetermined event as set by the user using the user input 16. For example, the event could be the cancellation of school due to weather conditions, a so-called “snow day.” When event detector 11 detects the event, it signals the processor 12 which will then take a predetermined action based on the event and on instructions previously input by the user. For example, in the event of a snow day, the alarm can simply be deactivated so as to not unnecessarily wake the user. In this way, a user's sleep is not interrupted when the reason for the alarm in the first place, in this example attending school (or getting children ready for school) is no longer a valid reason to wake.

The user can also set a different wake time when a predetermined event is detected. For example, if 6:00 a.m. is the normal school day wake-up time and 8:00 a.m. is the normal weekend wake-up time, then the detection of the snow day event can cause the processor to reset the alarm time from the 6:00 a.m. school day wake-up time to the 8:00 a.m. weekend wake-up time.

The processor can also adjust the alarm time based on the detected event. For example, if a one hour delay is detected for the start of school, then the alarm time can be adjusted by one hour. A two-hour delay can cause the alarm to be adjusted by two hours, etc. In this manner, the child or parent can be awakened at the appropriate time for the rescheduled event.

The event detecting unit 11 can function is several alternative ways. For example, it can monitor a radio station known to announce any school closings or delays and can apply voice recognition techniques to search for the occurrence of predetermined words. If the child's school is named, e.g., “Central Middle School,” then the event detecting unit can activate on recognizing these three words in the monitored data stream. The user can assume that the mention of the school's name on a preselected radio station is indicative of a school closing or delay and then set the desired action such as resetting the alarm clock for two hours later than the original wake time or deactivating the alarm altogether. Alternatively, the event detecting unit 11 can monitor the data stream for the occurrence of both a school name and other words such as “closed,” “one-hour delay,” etc., and can then take appropriate action as noted above.

School closings and delays are but one example of an event that could be monitored by the embodiment of FIG. 1. As a further example, a user that plans to wake early to play an outdoor sport such as golf, may set his alarm clock to monitor weather reports and to change or cancel the wake time if inclement weather is indicated. As yet a further example, a user who is waking to travel may set his alarm clock to reset (earlier or later than the original time) based on a change in travel plans, such as a rescheduled, delayed or canceled flight. Event detector 11 can monitor multiple data sources to look for the same event in the multiple data sources or to look for different events in each or different data sources. For example, multiple radio stations, television stations and websites can all be simultaneously monitored for news of a school closing.

As another example, the clock could be set to wake one user at 5:00 a.m. to catch a 7:00 a.m. flight and be set to wake another user at 6:00 a.m. to get children ready for school. In such an example, the event detecting using may be monitoring multiple news or radio channels to identify school delay or closing information and could also be monitoring an airline website to detect a change in flight status.

Event detecting unit 11 can monitor many different data sources, including one or more e-mail accounts, text message accounts, etc. It is increasingly common for schools to send notifications of school closings and delays via e-mail or text message. Airlines also are using e-mail and text messages to notify passengers of rescheduled, canceled and delayed flights. Telephone lines can similarly be monitored for relevant data.

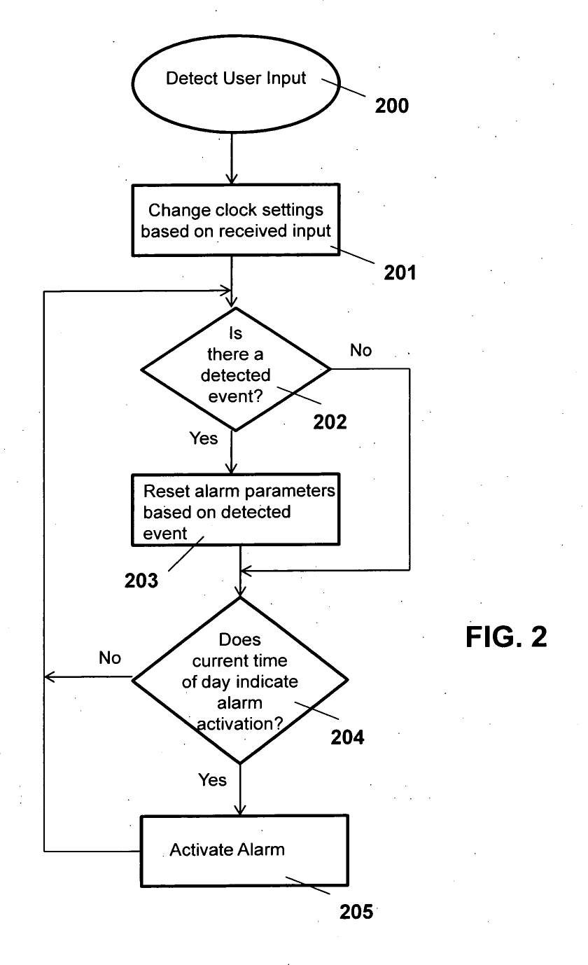

FIG. 2 is a flowchart showing one example of a method for implementing one embodiment of the invention. In the first step of this flowchart (step 200) user input is detected via the user input device 16. When such input is detected, processor 12 makes appropriate changes to the clock settings in step 201 as discussed above, including setting wake-up times, setting events and data sources to monitor.

In step 202, the system determines whether an event has been detected by event detecting unit 11. If an event is detected, the process proceeds to step 203 in which the stored clock parameters, such as wake-up time(s) are reset based on the event and as described above. If there is no detected event, then the process bypasses step 203.

The system next determines whether the current time of day indicates that an alarm should be activated in step 204. If the result of step 204 is yes, then the alarm is activated in step 205. If the time of day does not indicate an alarm activation, then the process transitions back to step 202 to continue monitoring for the predetermined event(s). Similarly, after alarm activation, the process transitions back to step 202.

At any time, step 200 can interrupt the process to accept new user input in step 200, at which time the clock settings are changed in step 201 and the process then transitions to step 202 as discussed above.

The precise order of the steps in FIG. 2 is not critical as will be understood to those of skill in the art. For example, steps 204-205 could be carried out before steps 202-203. Furthermore, many of these steps could be done in parallel.

In an alternative embodiment, the alarm clock can perform the event detecting functionality of event detecting unit 11 using the processor 12. For example, data from a monitored data source can be received through antenna system 10 or data source 19 and placed in memory 17. Processor 12 can then analyze the stored data to identify the occurrence of the predetermined event, such as certain received words.

The preceding description is for illustrative purposes only and there will be many additional variations and alternatives as will be understood to one of skill in the art.

1. An alarm clock that will adjust a wake-up time set by a user, the alarm clock comprising;
a processor;
a memory coupled to said processor, said memory having stored therein a wake-up time as set by a user;
an event detector coupled to said processor for detecting the occurrence of a predetermined external event from a source other than a user of the alarm clock;
said memory having stored therein instructions that, when executed, will cause said processor to perform the following steps:
(1) receiving a signal from said event detector indicating the occurrence of said predetermined external event; and
(2) adjusting said stored wake-up time based on said received signal.

2. The alarm clock of claim 1 wherein said step of adjusting comprises changing said stored wake-up time by a predetermined amount of time.

3. The alarm clock of claim 1 wherein said memory has additional instructions that will cause said processor to perform the additional step of activating an alarm based on said adjusted wake-up time.

4. The alarm clock of claim 1 wherein said step of adjusting comprises deactivating said alarm so that it will not wake the user at said stored wake-up time.

5. The alarm clock of claim 1 wherein said event detector monitors a data source for said predetermined external event.

6. The system of claim 5 wherein said data source is a radio transmission.

7. An alarm clock that will adjust a wake-up time set by a user based on a detected external event, the alarm clock comprising a processor and memory having stored therein instructions that, when executed, will cause said processor to perform the following steps:
(1) setting an initial wake-up time based on user input;
(2) recognizing the occurrence of a predetermined external event from a source other than a user of the alarm clock; and
(3) adjusting said initial wake up time based on said recognized occurrence of said predetermined external event.

8. The alarm clock of claim 7 wherein said step of adjusting comprises changing said stored wake-up time by a predetermined amount of time.

9. The alarm clock of claim 7 wherein said memory has additional instructions that will cause said processor to perform the additional step of activating an alarm based on said adjusted wake-up time.

10. The alarm clock of claim 7 wherein said step of adjusting comprises deactivating said alarm so that it will not wake the user at said stored wake-up time.

11. The alarm clock of claim 7 wherein said recognizing step comprises monitoring at least one public data transmission for the occurrence of at least one key word in said data transmission.

12. A method for operating an alarm clock comprising the following steps:
(1) receiving user input setting an initial wake-up time;
(2) monitoring a public broadcast source for the occurrence of a predetermined event; and
(3) adjusting said initial wake up time to an adjusted wake-up time based on said recognized occurrence of said predetermined event.

13. The method of claim 12 wherein said step of adjusting comprises changing said initial wake-up time by a predetermined amount of time.

14. The method of claim 12 wherein further comprising the step of activating an alarm based on said adjusted wake-up time.

15. The method of claim 12 wherein said step of adjusting comprises deactivating said alarm so that it will not wake the user at said initial wake-up time.

16. The method of claim 12 wherein said public broadcast comprises a radio broadcast.

17. The method of claim 12 wherein said public broadcast comprises a television broadcast.

18. The method of claim 12 wherein said predetermined event is the presence of at least one predetermined key word in the public broadcast.

19. The method of claim 12 wherein said predetermined event is the announcement of a school closing over a public radio station.
